(19) United States
(12) Patent Application Publication
(10) Pub. No.: US 2011/0270936 A1
(43) Pub. Date: Nov. 3, 2011

(54) SYSTEMS, METHODS, AND COMPUTER PROGRAMS FOR MONITORING A CONFERENCE AND COMMUNICATING WITH PARTICIPANTS WITHOUT JOINING AS A PARTICIPANT

(76) Inventors: DAVID MICHAEL GUTHRIE, Norcross, GA (US); DANIEL GARY OWENS, Atlanta, GA (US); SRINIMUKESH MANICKAM, Johns Creek, GA (US)

(21) Appl. No.: 13/078,132

(22) Filed: Apr. 1, 2011

Related U.S. Application Data
(63) Continuation-in-part of application No. 12/771,979, filed on Apr. 30, 2010.

(51) Int. Cl. G06F 15/16; H04M 3/42

(52) U.S. Cl. 709/206; 379/202.01

(57) ABSTRACT

Various embodiments of systems, methods, and computer programs are disclosed for monitoring a conference and communicating with participants without joining the conference. One embodiment is a method for monitoring an audio conference without joining as a participant. One such method comprises: a client device, which is associated with an individual who has not joined an audio conference, sending a request via a communication network to a conferencing system to be notified of a predetermined event associated with the audio conference; the conferencing system determining the occurrence of the predetermined event; the conferencing system sending a notification to the client device indicating the occurrence of the predetermined event; the client device presenting the notification to the individual; without joining the audio conference, the client device sending an out-of-conference message from the individual to the conferencing system; and the conferencing system presenting the out-of-conference message to one or more participants in the audio conference.

### CROSS-REFERENCE TO RELATED APPLICATIONS

This application is a continuation-in-part patent application of U.S. patent application Ser. No. 12/771,979, entitled “Conferencing Alerts” (First Named Inventor: Boland Jones; Attorney Docket No. 16003.1202U1) and filed on Apr. 30, 2010, which is hereby incorporated by reference in its entirety.

### BACKGROUND

Currently, there are a number of conference solutions for enabling people to conduct live meetings, conferences, presentations, or other types of gatherings via the Internet, the public switched telephone network (PSTN), or other voice and/or data networks. Participants typically use a telephone, computer, or other communication device that connects to a conference system. The meetings include an audio component and a visual component, such as, a shared presentation, video, whiteboard, or other multimedia, text, graphics, etc. These types of convenient conference solutions have become an indispensable form of communication for many businesses and individuals.

Despite the many advantages and commercial success of existing conference, meeting, grouping or other types of gathering systems, there remains a need in the art for improved conference, meeting, grouping or other types of gathering systems, methods, and computer programs.

### SUMMARY

Various embodiments of systems, methods, and computer programs are disclosed for monitoring a conference and communicating with participants without joining the conference. One embodiment is a method for monitoring an audio conference without joining as a participant. One such method comprises: a client device, which is associated with an individual who has not joined an audio conference, sending a request via a communication network to a conferencing system to be notified of a predetermined event associated with the audio conference; the conferencing system determining the occurrence of the predetermined event; the conferencing system sending a notification to the client device indicating the occurrence of the predetermined event; the client device presenting the notification to the individual; without joining the audio conference, the client device sending an out-of-conference message from the individual to the conferencing system; and the conferencing system presenting the out-of-conference message to one or more participants in the audio conference.

Another embodiment is a computer system for monitoring an online conference without joining as a participant. One such computer system comprises: a conference platform and a client device. The conference platform provides an online conference to a plurality of participants via a communication network. The client device is operated by a nonparticipant of the online conference and comprises a processor, a memory, and a conferencing notification application embodied in the memory and executed by the processor. The conferencing notification application comprises: logic configured to send a request to the conference platform to be notified of a predetermined event associated with the online conference without joining the online conference; logic configured to receive a notification from the conference platform when the predetermined event occurs; and logic configured to enable the nonparticipant to send a message to one or more of the participants without joining the online conference.

A further embodiment is a desktop notification computer program embodied in a computer readable medium and executed by a processor. The desktop notification computer program monitors a conference and provides notifications to a graphical user interface associated with a desktop. The desktop notification computer program comprises: logic configured to send a request to a conference platform to be notified of an occurrence of an event associated with a conference without a user joining as a participant; logic configured to receive a notification from the conference platform when the predetermined event occurs; logic configured to present the notification to a desktop associated with a graphical user interface; and logic configured to enable the user to send a message to one or more participants in the audio conference without joining the conference.

### BRIEF DESCRIPTION OF THE DRAWINGS

FIG. 1 is a block diagram illustrating an embodiment of a computer system for monitoring a conference and/or communicating with conference participants without joining the conference as a participant.

FIG. 2 is a screen shot illustrating an embodiment of a desktop user interface for accessing exemplary services provided by the conferencing notification application of FIG. 1.

FIG. 3 is a user interface screen shot illustrating another embodiment of a mobile user interface for accessing services provided by the conferencing notification application of FIG. 1.

FIG. 4 is a screen shot illustrating an embodiment of a method for launching a conferencing notification menu via the mobile user interface of FIG. 3.

FIG. 5 is a user interface screen shot illustrating an embodiment of a conferencing notification menu in the desktop user interface of FIG. 2.

FIG. 6 is a block diagram illustrating an exemplary implementation of the conferencing API in FIG. 1.

FIG. 7 is a user interface screen shot illustrating an embodiment of a conferencing notification functionality displayed in the mobile user interface of FIG. 3.

FIG. 8 illustrates the user interface screen shot of FIG. 7 for enabling a user to join a conference via the conferencing notification functionality.

FIG. 9 illustrates the user interface screen shot of FIG. 7 for enabling a user to send messages to conference participants without joining the conference as a participant.

FIG. 10 is a user interface screen shot illustrating an embodiment of a conference interface for an exemplary mobile computing device.

FIG. 11 is a flowchart illustrating the architecture, operation, and/or functionality of an embodiment of the conferencing notification application of FIG. 1.

FIG. 12 is a flowchart illustrating the architecture, operation, and/or functionality of another embodiment of the conferencing notification application of FIG. 1.

FIG. 13 is a user interface screen shot illustrating an embodiment of a conference scheduler functionality.

FIG. 14 is a flowchart illustrating the architecture, operation, and/or functionality of another embodiment of the conferencing notification application of FIG. 1 for enabling nonparticipants to communicate with participants without joining the conference.

### DETAILED DESCRIPTION

Various embodiments of systems, methods, and computer programs are disclosed for enabling a user of a computing device (referred to as a “nonparticipant”) to monitor a conference and/or communicate with conference participants without necessarily joining the conference as a participant. The conference monitored by the nonparticipant may comprise any online conference, meeting, grouping, or other types of gatherings (collectively, a “conference”, with a system that provides the conference being referred to as a “conferencing system”) for any variety of purposes of one or more people, groups or organizations (including combinations thereof and collectively referred to as “participants”) with or without an audio component, including, without limitation, enabling simulcast audio with such conference for the participants. Exemplary embodiments of the conference and conferencing system and related features may be implemented as described in the parent patent application, U.S. patent application Ser. No. 12/771,979, the entire contents of which are hereby incorporated by reference into this specification.

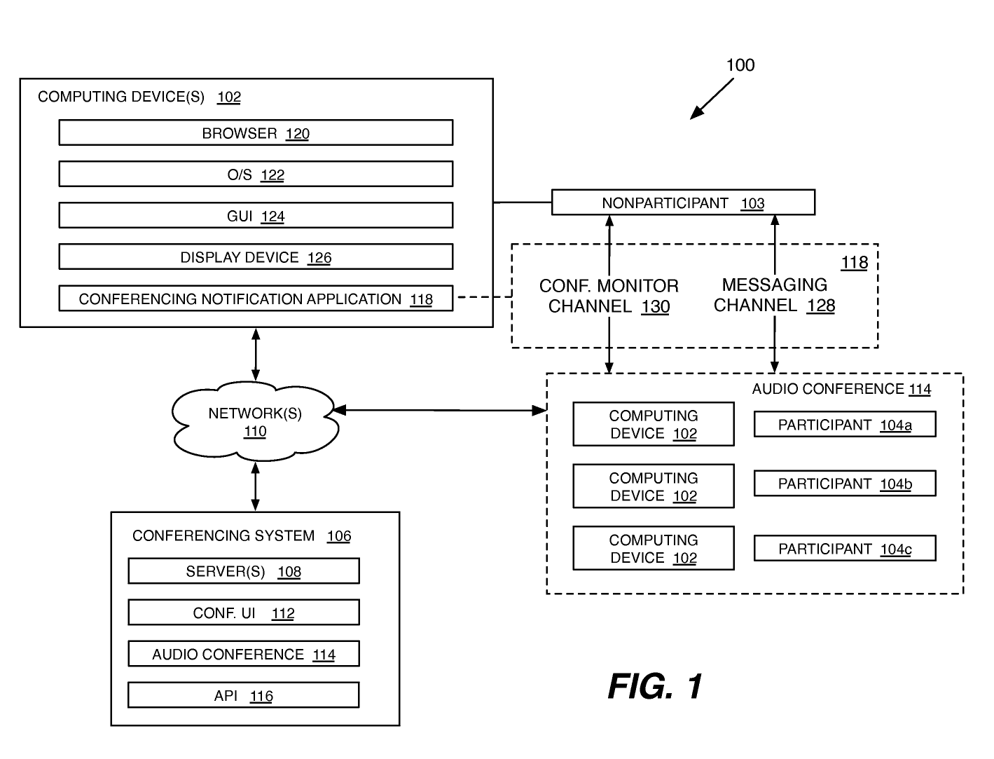

FIG. 1 illustrates a computer system 100 representing an exemplary working environment for enabling a nonparticipant 103 to monitor the conference and/or communicate with the conference participants 104 without joining the conference. The computer system 100 comprises a plurality of computing devices 102 in communication with a conferencing system 106 and server(s) 108 via one or more communication networks 110. The network(s) 110 may support wired and/or wireless communication via any suitable protocols, including, for example, the Internet, the Public Switched Telephone Network (PSTN), cellular or mobile network(s), local area network(s), wide area network(s), or any other suitable communication infrastructure. The conferencing system 106 establishes a conference (e.g., an audio conference 114) between computing devices 102 associated with participants 104a-104c. The audio conference 114 may have a corresponding online component presented to participants 104a-104c via a conference user interface 112. In an embodiment, the conference user interface 112 may be configured in any of the ways described in the above-referenced parent patent application, or others, to provide a visually engaging conference experience to participants.

In contrast to the participants 104a-104c, the computing device 102 associated with the nonparticipant 103 is at least initially not connected to the conference or audio conference 114 as a participant. The nonparticipant 103 may be a scheduled host or a scheduled participant who has not yet joined the conference or another individual or group of individuals who wishes to monitor the conference and/or communicate with the participants 104 without necessarily joining the conference. The terms “host” and “participant” merely refer to different user roles or permissions associated with the conference. For example, the “host” may be the originator of the conference and, consequently, may have user privileges that are not offered to the participants. Nonetheless, it should be appreciated that the terms “host,” “participant,” and “user” may be used interchangeably depending on the context in which it is being used and that the term “nonparticipant” merely refers to a user that is not currently connected to the conference via conferencing system 106.

The computing devices 102 may comprise any desirable computing device, which is configured to communicate with the conferencing system 106 and the server 108 via the networks 110. The computing device 102 may comprise, for example, a personal computer, a desktop computer, a laptop computer, a mobile computing device, a portable computing device, a smart phone, a cellular telephone, a landline telephone, a soft phone, a web-enabled electronic book reader, a tablet computer, or any other computing device capable of communicating with the conferencing system 106 and/or the server 108 via one or more networks 110. The computing device 102 may include a display device 126, a processor, memory, and software, including an operating system 122, a graphic user interface 124, and client software (e.g., a browser 120, plug-in, or other functionality) configured to facilitate communication with the conferencing system 106 and the server 108. It should be appreciated that the hardware, software, and any other performance specifications of the computing device 102 are not critical and may be configured according to the particular context in which the computing device 102 is to be used.

The computing device 102 associated with the nonparticipant 103 includes a conferencing notification application 118 configured to provide various services, features, and functionality for enabling the user to monitor the conference and/or communicate with participants 104 while not an active participant in the conference.

The conferencing system 106 generally comprises a communication system for establishing an audio conference 114 between the computing devices 102. The conferencing system 106 may support audio via a voice network and/or a data network. In one of a number of possible embodiments, the conferencing system 106 may be configured to support, among other platforms, a Voice Over Internet Protocol (VoIP) conferencing platform such as described in U.S. patent application Ser. No. 11/637,291 entitled “VoIP Conferencing,” filed on Dec. 12, 2006, which is hereby incorporated by reference in its entirety. It should be appreciated that the conferencing system 106 may support various alternative platforms, technologies, protocols, standards, features, etc. Regardless of the communication infrastructure, the conferencing system 106 may be configured to establish a data and/or audio connection with the computing devices 102. In the case of nonparticipants 103, the connection may be a data connection, while in the case of participants 104 the connection may be an audio connection, although in some embodiments the audio portion may be removed. The conferencing system 106 may establish the audio conference 114 by combining audio streams associated with the participant computing devices 102.

One of ordinary skill in the art will appreciate that the conferencing notification application 118 (and any associated or other modules described herein) may be implemented in software, hardware, firmware, or a combination thereof. In one embodiment, the systems are implemented in software or firmware that is stored in a memory and that is executed by a suitable instruction execution system, such as, for example, an instruction system operable on a computing device 102 or the server(s) 108. In software or firmware embodiments, the logic may be written in any suitable computer language. In hardware embodiments, the systems may be implemented with any or a combination of the following, or other, technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As illustrated in FIG. 1, the conferencing notification application 118 resides on the computing device 102 of the nonparticipant 103. The conferencing notification application 118 supports two main communication channels between the conferencing system 106 and the computing device 102 associated with the nonparticipant 103. The first channel comprises a conference monitor channel 130 that provides various features related to monitoring events associated with the conference and providing conference alerts or notifications to the nonparticipant 103. The second channel comprises an out-of-conference messaging channel 128, which enables the nonparticipant 103 to send and/or receive messages from the participants 104 without necessarily joining the conference.

In general, the conferencing notification application 118 resides on the computing device 102 and communicates with the conferencing system 106. In the embodiment illustrated in FIG. 1, the conferencing notification application 118 is illustrated as residing on computing device 102, although it should be appreciated that the logic may be located at, and/or controlled by, the conferencing system 106 or other computer devices, systems, etc. The conferencing notification application 118 may be configured to monitor the conference and notify the nonparticipant 103 of any desirable event (e.g., that a conference has started, participant(s) 104 have joined the conference by showing the name and number of participants 104 via a push from the application, among other mechanisms). As participants 104 join, the notification may maintain a count of the number of participants 104. It may also allow the nonparticipant 103 to quickly enter the conference from the application, automatically enter the conference upon the occurrence of a predetermined event, modify settings prior to an audio conference 114 starting, and provide easy access to account numbers. The conferencing notification application 118 may display, for example, an icon or other user interface control or feature in a system application tray of the computing device 102, which exposes a menu or other functionality that enables users to modify certain settings, configurations, options, etc.

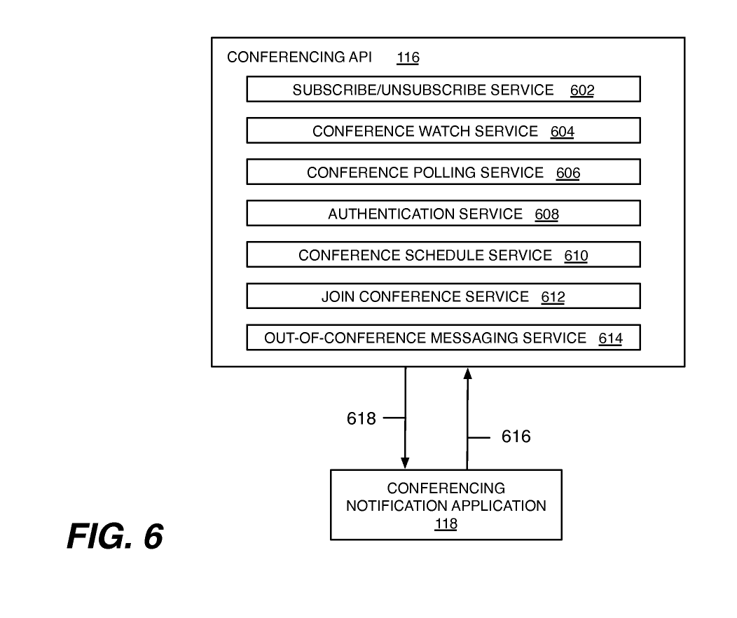

While the conferencing notification application 118 is running on computing device 102, it communicates with the conferencing infrastructure using, for example, a conferencing API 116 (FIG. 6). The communications may comprise, for example, status checks of the user's conferencing bridges or locations to determine if there are any active participants 104. In the event that someone has entered the user's location or joined one of their bridges via a phone, this activity may be transmitted to the application as a status update. The update may include other information about the newly joined participant 104 such as the incoming phone number, email address, name, or other identifiable details that may determined using, for example a caller ID database.

The conferencing notification application 118 alerts the nonparticipant 103 by displaying a message on the display device 126 of the computing device 102. The message may appear for a pre-determined amount of time, which may be configurable in the application's settings. The content of the message may further include the details transmitted in the status update mentioned above. The message display may also provide a mechanism for the user to acknowledge the message by, for example, cancelling the message, joining a conference, or sending a message to participant(s) 104. If the user chooses to cancel a particular message, subsequent messages will appear as new participants 104 join a location or audio bridge, with a running tally indicating the total number of participants. If the user chooses to join their own location, the alerts will cease until the event has ended.

Referring to FIGS. 1-14, in an embodiment, the conferencing notification application 118 generally comprises logic for monitoring an audio conference 114 and the content/functionality presented in a conference interface user interface 112 and providing alerts, notifications, or other messages (collectively referred to as “alerts” or “notifications”) to the nonparticipant 103. An alert may comprise audio, video, text, graphics, or other information embodied in any medium and presentable via hardware and/or software components supported by the computing device 102, including, a browser 120, an operating system 122, a GUI 124, a microphone, and a display device 126, such as, for example, a touchscreen.

In general operation, the conferencing notification application 118 may provide alerts based on various events monitored by the conferencing system 106. For instance, the conferencing notification application 118 may notify a host when an audio conference 114 or conference has started and alert the host to who has joined the audio conference 114 or accessed the conference by showing, for example, the participant name, the number of current participants, etc. The alerts may be implemented using a push methodology by which the alerts are “pushed” from the conferencing system 106, a pull methodology by which the alerts are “pulled” from the conferencing system 106 by the computing device 102 using, for example, the conferencing API 116, or other alert protocols, services, methodologies, etc. As participants 104 join the audio conference 114 or the associated conference, the conferencing system 106 maintains a log or counter of the number and identity of participants 104 and provides related or other information to the host. The conferencing notification application 118 may also enable the host to conveniently access the conference interface from within the application (e.g., via a menu, key shortcut, or other user interface control), as well as modify conferencing, notification or account settings prior to or during a virtual conference.

The conferencing notification application 118 may incorporate a user interface control for enabling users to launch the application or conveniently access certain functions or features of the application (e.g., configure remote or local settings, join a virtual conference, etc.). The user interface control may be presented in various ways depending on, for example, the configuration of the operating system 122, the GUI 124, the display type and/or size, and other hardware and/or software characteristics.

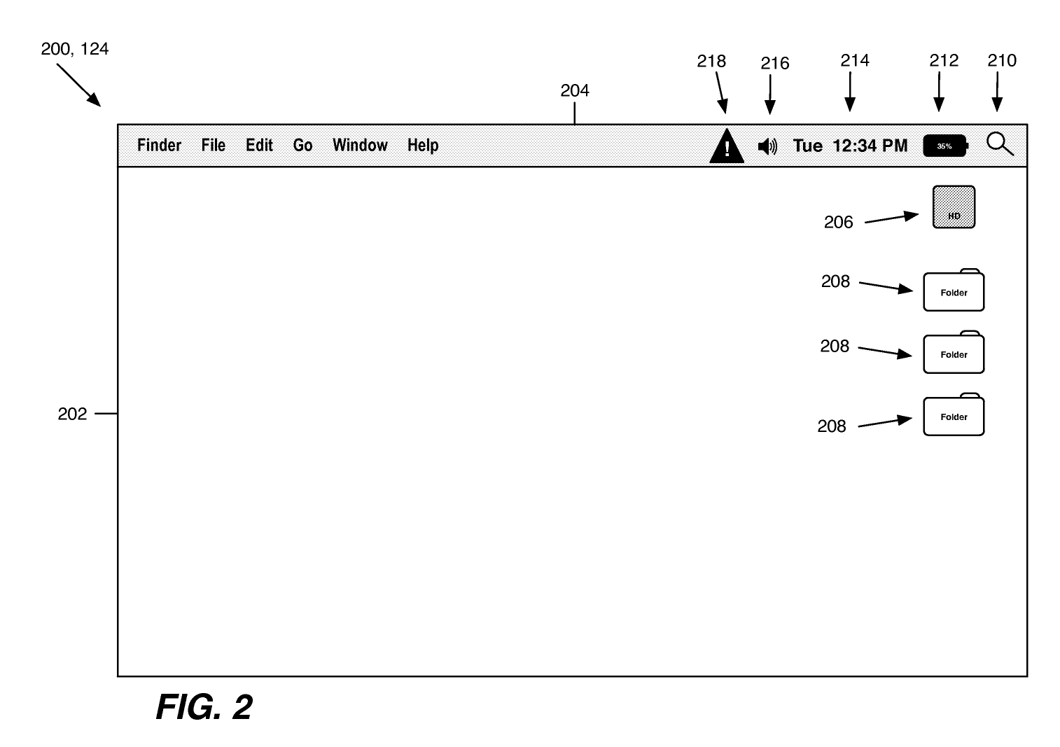

FIG. 2 illustrates an embodiment of a user interface control 218 implemented in a desktop environment 200 for accessing the conferencing notification application 118. The desktop environment 200 comprises a desktop 202 that may display one or more icons, folders, wallpaper, widgets, or other desktop objects associated with the system. The desktop objects enable the user to easily access, configure, or modify aspects of the operating system 122 and/or other software or features of the computing device 102. In the embodiment of FIG. 2, the desktop 202 may display a system application tray 204, one or more folder icons 208 for organizing files, and a hard drive icon 206 for accessing a hierarchical folder structure for accessing files stored on the computing device 102.

The user interface control 218 may be displayed anywhere within the desktop 202. In FIG. 2, the user interface control 218 is displayed on a system application tray 204. The system application tray 204 may display various icons (e.g., a search icon 210, a battery level icon 212, a system time icon 214, a volume icon 216, or any other system icon, application icon, or user-defined icon).

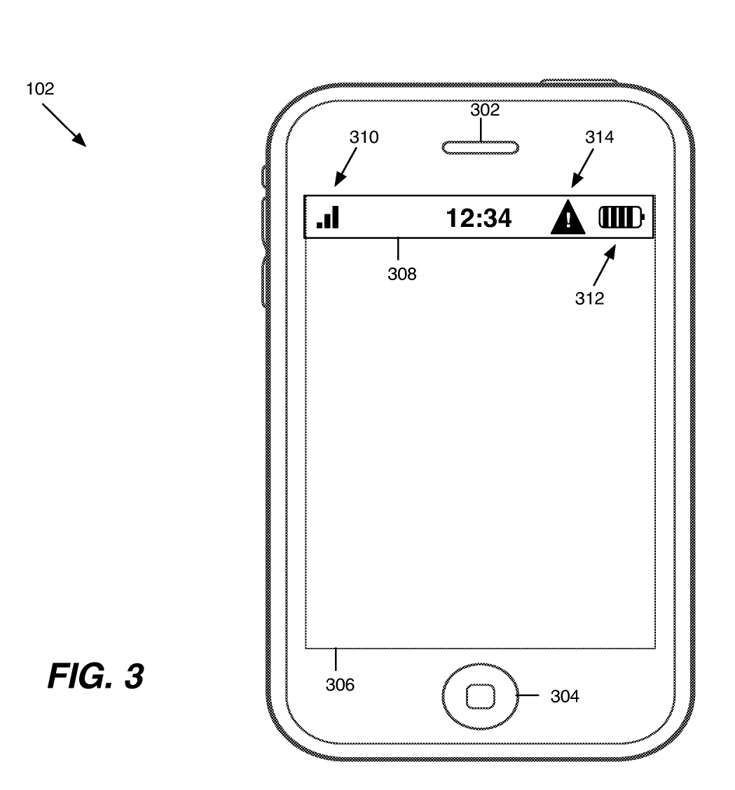

FIG. 3 illustrates another embodiment of a user interface control 314 for providing user access to certain aspects of the conferencing notification application 118. In this embodiment, the computing device 102 comprises a mobile device, such as, a mobile telephone, tablet computer, etc. having a touchscreen display. The touchscreen display comprises a display device that can detect the presence and location of a touch within the display area by, for example, a finger or hand or passive objects, such as, a stylus, pen, or other object. The touchscreen display may be based on any current or future touchscreen technology, and may employ various forms of input gestures for performing associated functions.

As illustrated in FIG. 3, the mobile device includes a microphone 302 and various hardware keys, including, for example, a scroll button 304 for navigating the GUI 124. The mobile device includes a notification bar 308 for displaying system information, such as, signal strength icon 310, battery level icon 312, or any other system of application information. The notification bar 308 may be expandable based on touch input to display additional notification icons.

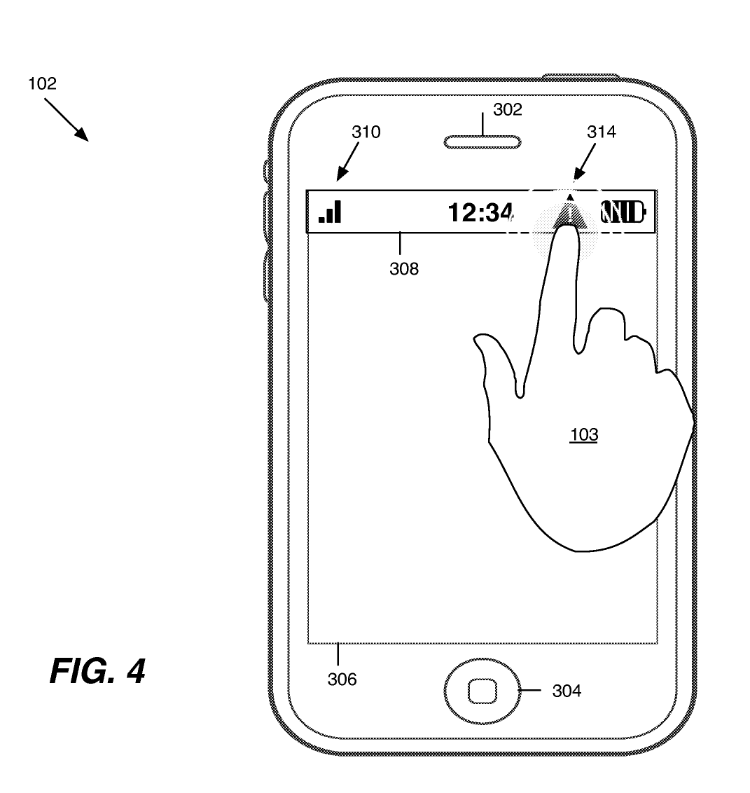

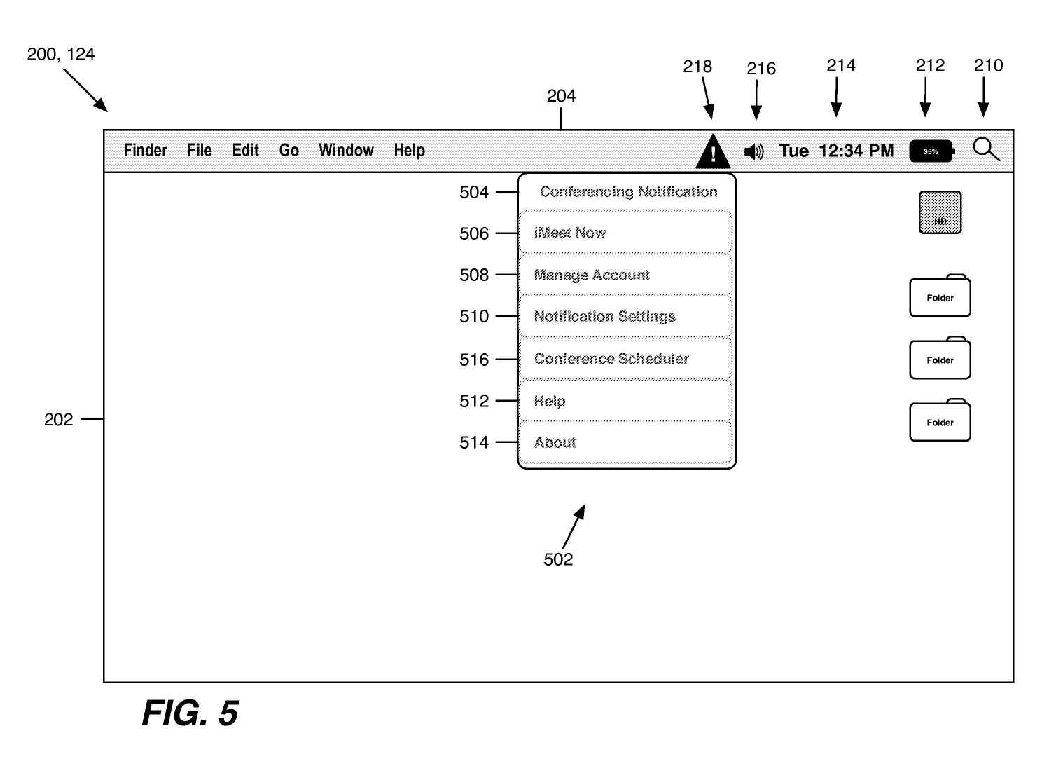

Regardless of the type and configuration of the computing device 102, the conferencing notification application 118 may be accessed by selecting the user interface control. For example, a user may select the user interface control 314 (FIG. 4) to display a conferencing notification menu 502 (FIG. 5). The conferencing notification menu 502 may comprise a display header 504 and one or more additional user interface controls for selecting certain configuration or other options. In the embodiment of FIG. 5, conferencing notification menu 502 displays an iMeet Now button 506, a Manage Account button 508, a Notification Settings button 510, a Conference Scheduler button 516, a Help button 512, and an About button 514.

The iMeet Now button 506 may enable the user to connect to the conferencing system 106. When the user selects the button 506, the conferencing notification application 118 may launch the browser 120 and enable the user to join an audio conference 114 and access the conference user interface 112. The Manage Account button 508 may enable the user to configure an account profile. In an embodiment, the user may configure the parameters via the conferencing notification application 118, and the parameters subsequently provided to the conferencing system 106 via the conferencing API 116. In alternative embodiments, the Manage Account button 508 may direct the user to a web page provided by the conferencing system 106, which receives the configuration parameters. The Notification Settings button 510 may operate in a similar manner to enable the user to configure parameters associated with the conferencing notification. For example, the conferencing notification parameters may specify any of the following, or other, parameters: alert push enabled/disabled; alert pull enabled/disabled; alert frequency; and alert types.

In operation, the conferencing notification application 118 may communicate with the conferencing system 106 using conferencing API(s) 116. The conferencing API(s) 116 may enable the conferencing notification application 118 to submit requests 616 to, and receive responses 618 from, the conferencing system 106 (FIG. 6). These communications may include, for example, status checks of the user's conferences to determine if there are any active participants 104, status checks of other participant's conferences. In the event that someone has entered the user's conference or joined one of their bridges via a phone, this activity may be transmitted to the conferencing notification application 118 as a status update or alert. The update may include other information about the newly joined participants, such as described in the above-reference parent patent application.

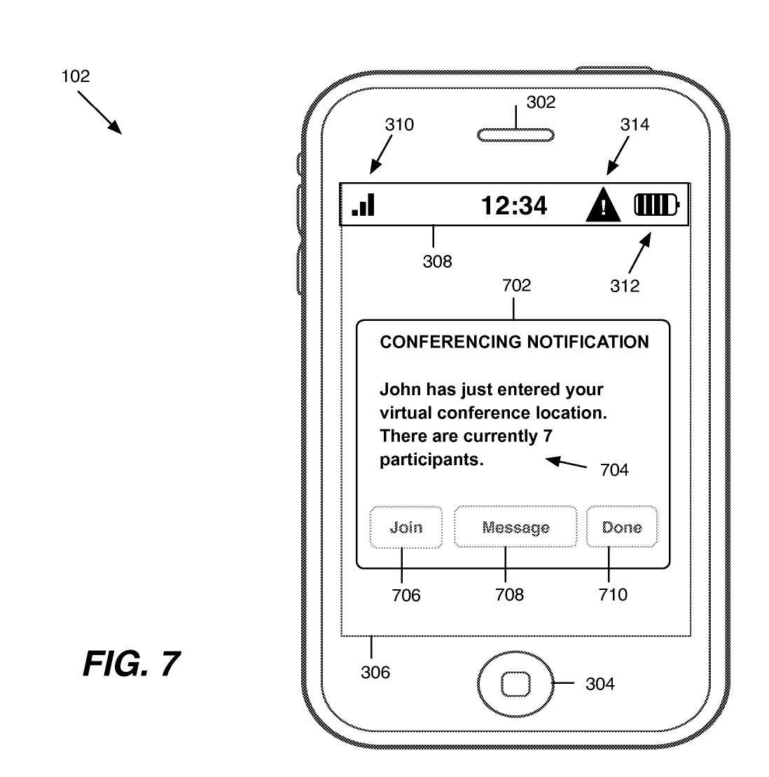

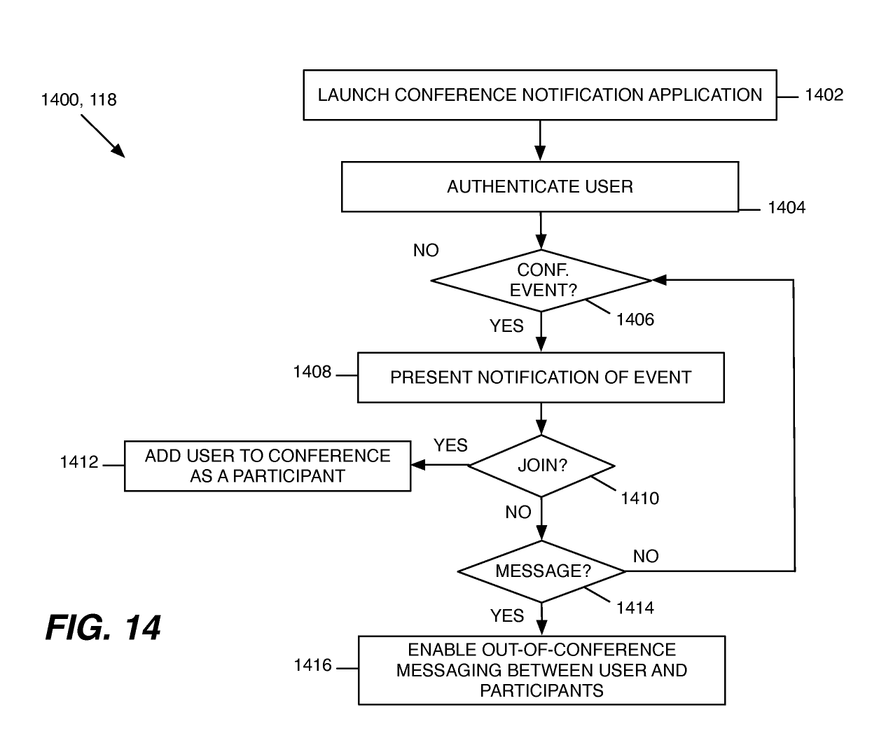

The alerts provided to the conferencing notification application 118 may be presented on the display device 126. FIG. 7 illustrates an exemplary message or alert 702 notifying the nonparticipant 103 of the identity of a newly joined participant and the current number of participants. The alert 702 may appear for a predetermined amount of time, which may be configurable via the Notification Settings button 510, or the user may cancel the alert message 702 by selecting the Done button 710. As described below in more detail in connection with FIG. 14, the alert message 702 may also include a Message button 708 for enabling the nonparticipant 103 to compose and send messages to the participants 104 without joining the conference. Such out-of-conference messages may be handled through the messaging channel 128 (FIG. 1) or the out-of-conference messaging service 614 (FIG. 6).

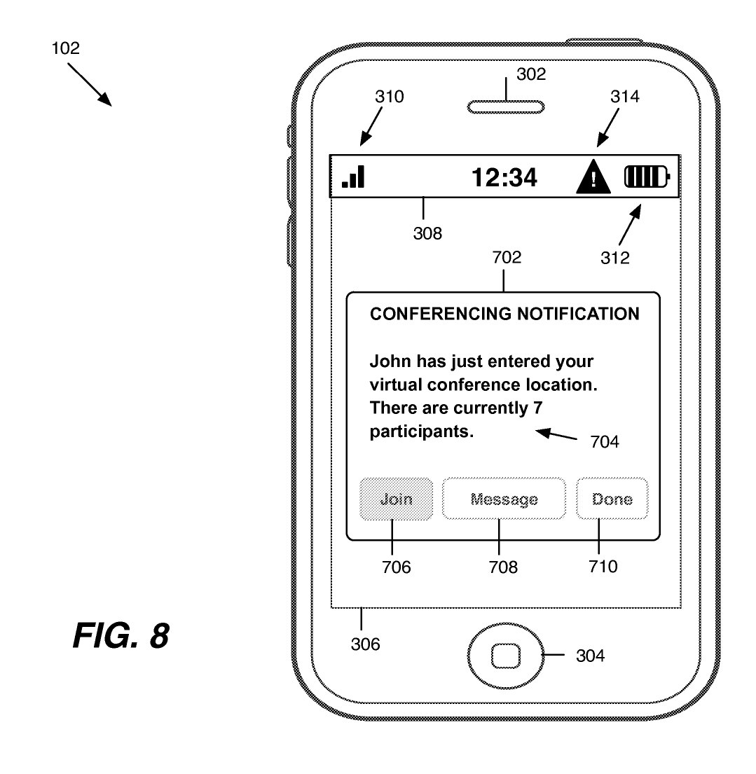

It should be appreciated that the content and/or format of the alert 702 may vary depending on, for example, the events being monitored by the conferencing system 106. The alert 702 may include a convenient mechanism for enabling the user to join the audio conference 114 and/or the associated conference from the displayed alert 702. In an embodiment, the conferencing notification application 118 may prompt the nonparticipant to join the audio conference 114 and/or the associated conference. As illustrated in FIG. 7, the displayed alert 702 may include a Join button 706. When selected (FIG. 8), the conferencing notification application 118 may initiate a process to enable the user to join the audio conference 114 and present a conferencing user interface 112 on the computing device 102. The conferencing notification application 118 may also automatically add the nonparticipant 103 to the conference upon the occurrence of a predetermined event.

If the user chooses to cancel a particular message or the message expires without the nonparticipant 103 joining the conference, the conferencing system 106 may continue to send alerts as events occur. If the nonparticipant 103 chooses to join the conference, the conferencing system 106 may disable alerts.

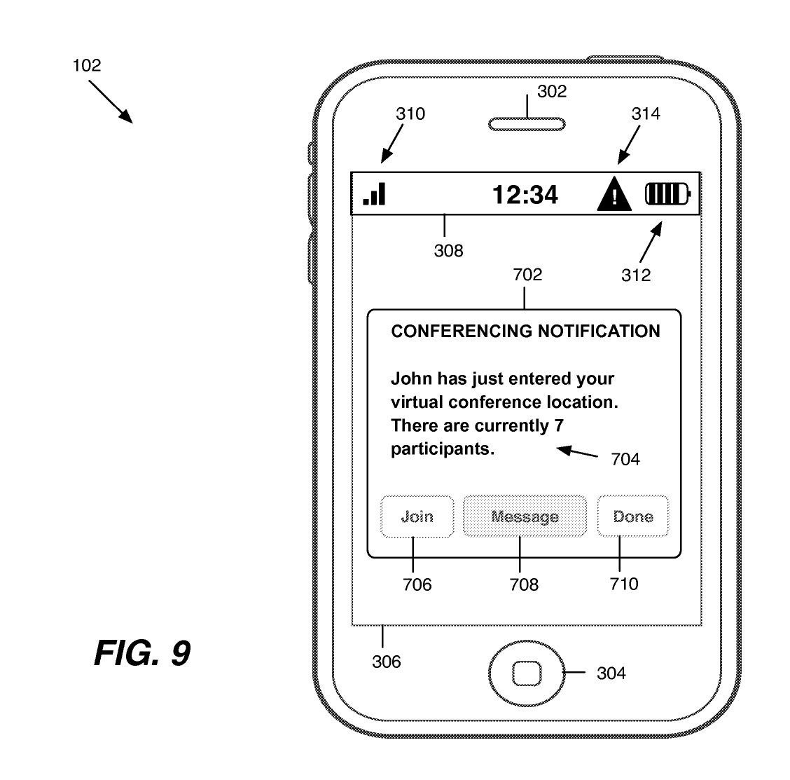

As illustrated in FIG. 9, the nonparticipant 103 may compose and send messages to the participants 104 without joining the conference by selecting the Message button 708 (FIG. 9). The nonparticipant 103 may manually enter text messages, audio messages, or any other messages via suitable user interface controls. In an embodiment, the conferencing notification application 118 may also provide a default list of short responses (e.g., “Be there in five minutes.”), which may be particularly convenient for computing devices 102 with smaller screen sizes.

To implement the conferencing notification application 118, the conferencing system 106 may support various web services for exchanging structured information with the conferencing notification application 118. The web services may be implemented using any suitable protocol. In one embodiment, the web services may be implemented via a Representation State Transfer (REST) architecture or system. In alternative embodiments, the web services may be implemented via the Simple Object Access Protocol (SOAP) using Extensible Markup Language (XML) as the messaging format. The conferencing system 106 may respond to web service calls from the conferencing notification application 118 by either returning the requested information immediately or by initiating the request and then providing the results (later) via a polling action. One of ordinary skill in the art will appreciate that any suitable methodology may be used to exchange data between the conferencing notification application 118 and the conference system 106. For example, the data may be exchanged in real-time, near real-time, using push and/or pull notifications, or any combination thereof, any of which may be customized by the user.

FIG. 6 illustrates various exemplary web services for implementing one or more aspects of the conferencing notification application 118. The web services may comprise any of the following, or other, web services: a subscribe/unsubscribe service 602; a conference watch service 604; a conferencing polling service 606; an authentication service 608; a conference schedule service 610; a join conference service 612; and an out-of-conference messaging service 614. Each of these web services are generally described below with reference to exemplary request and response XML messages.

The subscribe/unsubscribe service 602 may be implemented with a Subscribe( ) call that establishes authorization to use the resources provided by the conferencing system 106. The Subscribe( ) call may be the first call made by the conferencing notification application 118 to the conferencing system 106. In an embodiment, the Subscribe( ) call may require an authorization response before the conferencing notification application 118 may access other services. In this regard, the subscribe/unsubscribe service 602 may be configured without a security token in the SOAP header. The other web services may be implemented with the security token (e.g., a session ID obtained with the Subscribe( ) call).

An exemplary XML request for the Subscribe( ) call may be configured as follows:

<?xml version=“1.0” encoding=“utf-8”?>
<soap:Envelope xmlns:xsi=“http://www.w3.org/2001/XMLSchema-
instance”
xmlns:xsd=“http://www.w3.org/2001/XMLSchema” xmlns:soap=
“http://schemas.xmlsoap.org/soap/envelope/”>
<soap:Body>
<Subscribe xmlns=“http://pia.premiereglobal.com/”>
<ClientID>string</ClientID><ClientPW>string</ClientPW>
<WebID>string</WebID>
<WebPW>string</WebPW>
</Subscribe>
</soap:Body>
</soap:Envelope>

An exemplary XML response for the Subscribe( ) call may be configured as follows:

<?xml version=“1.0” encoding=“utf-8”?>
<soap:Envelope xmlns:xsi=“http://www.w3.org/2001/XMLSchema-
instance”
xmlns:xsd=“http://www.w3.org/2001/XMLSchema” xmlns:soap=“http://
schemas.xmlsoap.org/soap/envelope/”>
<soap:Body>
<SubscribeResponse xmlns=“http://pia.premiereglobal.com/”>
<SubscribeResult>
<ResultCode>ResultCode</ResultCode>
<SessionID>string</SessionID>
</SubscribeResult>
</SubscribeResponse>
</soap:Body>
</soap:Envelope>

An Unsubscribe( ) call may be made to unsubscribe the user from the web services when the conferencing notification application 118 is closed. The call may terminate the session with the conferencing system 106. Further interactions with the conferencing system 106 may require a subsequent Subscribe( ) call to be made by the conferencing notification application.

An exemplary XML request for the Unsubscribe( ) call may be configured as follows:

<?xml version=“1.0” encoding=“utf-8”?>
<soap:Envelope xmlns:xsi=“http://www.w3.org/2001/XMLSchema-
instance”
xmlns:xsd=“http://www.w3.org/2001/XMLSchema” xmlns:soap=“http://
schemas.xmlsoap.org/soap/envelope/”>
<soap:Header>
<SoapSecurityHeader xmlns=“http://pia.premiereglobal.com/”>
<SessionID>string</SessionID>
</SoapSecurityHeader>
</soap:Header>
<soap:Body>
<Unsubscribe xmlns=“http://pia.premiereglobal.com/” />
</soap:Body>
</soap:Envelope>

An exemplary XML response for the Unsubscribe( ) call may be configured as follows:

<?xml version=“1.0” encoding=“utf-8”?>
<soap:Envelope xmlns:xsi=http://www.w3.org/2001/XMLSchema-
instance
xmlns:xsd=“http://www.w3.org/2001/XMLSchema” xmlns:soap=“http://
schemas.xmlsoap.org/soap/envelope/”>
<soap:Body>
<UnsubscribeResponse xmlns=“http://pia.premiereglobal.com/”>
<UnsubscribeResult>
<ResultCode>ResultCode</ResultCode>
</UnsubscribeResult>
</UnsubscribeResponse>
</soap:Body>
</soap:Envelope>

The conference watch service 604 may invoke a SetConferenceWatch( ) call that establishes a conference watch, which enables the conferencing system 106 to begin sending alerts to the conferencing notification application 118. After setting a conference watch, the user may receive notifications or alerts for conference(s) associated with the user, including, for example, when a participant 104 joins or leaves a conference, when a participant speaks during an audio conference 114, when a participant posts or receives information associated with a social networking system, etc.

The conference watch service 604 may be useful for hosts who are too busy to join a conference, do not wish to join the conference, or are otherwise unable to join the conference but want to monitor the activity of the conference. For example, the host may be interested in joining the conference, for example, but only after a particular person has joined or some other event has occurred. The host may view the alert messages as they are provided by the conferencing system 106 and displayed by the computing device 102. When the desired event has occurred, the host may elect to join the conference. As described below, the alerts may be retrieved from the conferencing system 106 via the conference polling service 606.

An exemplary XML request for the SetConferenceWatch( ) call may be configured as follows:

<?xml version=“1.0” encoding=“utf-8”?>
<soap:Envelope xmlns:xsi=“http://www.w3.org/2001/XMLSchema-
instance”
xmlns:xsd=“http://www.w3.org/2001/XMLSchema” xmlns:soap=“http://
schemas.xmlsoap.org/soap/envelope/”>
<soap:Header>
<SoapSecurityHeader xmlns=“http://pia.premiereglobal.com/”>
<SessionID>string</SessionID>
</SoapSecurityHeader>
</soap:Header>
<soap:Body>
<SetConferenceWatch xmlns=“http://pia.premiereglobal.com/”>
<ConferenceID>string</ConferenceID>
</SetConferenceWatch>
</soap:Body>
</soap:Envelope>

An exemplary XML response for the SetConferenceWatch( ) call may be configured as follows:

<?xml version=“1.0” encoding=“utf-8”?>
<soap:Envelope xmlns:xsi=“http://www.w3.org/2001/XMLSchema-
instance”
xmlns:xsd=“http://www.w3.org/2001/XMLSchema” xmlns:soap=“http://
schemas.xmlsoap.org/soap/envelope/”>
<soap:Body>
<SetConferenceWatchResponse xmlns=“http://pia.premiereglobal.com/”>
<SetConferenceWatchResult>
<ResultCode>ResultCode</ResultCode>
</SetConferenceWatchResult>
</SetConferenceWatchResponse>
</soap:Body>
</soap:Envelope>

The conference watch service 604 may also invoke a ClearConferenceWatch( ) call that may be used to clear a previously established conference watch. Removing a conference watch may cause the alerts for the specified conference to be disabled. After clearing the conference watch, the user will no longer receive alerts.

An exemplary XML request for the ClearConferenceWatch( ) call may be configured as follows:

<?xml version=“1.0” encoding=“utf-8”?>
<soap:Envelope xmlns:xsi=“http://www.w3.org/2001/XMLSchema-
instance”
xmlns:xsd=“http://www.w3.org/2001/XMLSchema” xmlns:soap=“http://
schemas.xmlsoap.org/soap/envelope/”>
<soap:Header>
<SoapSecurityHeader xmlns=“http://pia.premiereglobal.com/”>
<SessionID>string</SessionID>
</SoapSecurityHeader>
</soap:Header>
<soap:Body>
<ClearConferenceWatch xmlns=“http://pia.premiereglobal.com/”>
<ConferenceID>string</ConferenceID>
</ClearConferenceWatch>
</soap:Body>
</soap:Envelope>

An exemplary XML response for the ClearConferenceWatch( ) call may be configured as follows:

<?xml version=“1.0” encoding=“utf-8”?>
<soap:Envelope xmlns:xsi=http://www.w3.org/2001/XMLSchema-
instance
xmlns:xsd=“http://www.w3.org/2001/XMLSchema” xmlns:soap=“http://
schemas.xmlsoap.org/soap/envelope/”>
<soap:Body>
<ClearConferenceWatchResponse xmlns=“http://
pia.premiereglobal.com/”>
<ClearConferenceWatchResult>
<ResultCode>ResultCode</ResultCode> </
ClearConferenceWatchResult>
</ClearConferenceWatchResponse>
</soap:Body>
</soap:Envelope>

The conferencing polling service 606 may invoke a PollForMessages( ) call, which is used to request events from a watched conference. In response to the request, the conferencing notification application 118 will receive events associated with the watched conference.

An exemplary XML request for the PollForMessages( ) all may be configured as follows:

<?xml version=“1.0” encoding=“utf-8”?>
<soap:Envelope xmlns:xsi=“http://www.w3.org/2001/XMLSchema-
instance”
xmlns:xsd=“http://www.w3.org/2001/XMLSchema” xmlns:soap=“http://
schemas.xmlsoap.org/soap/envelope/”>
<soap:Header>
<SoapSecurityHeader xmlns=“http://pia.premiereglobal.com/”>
<SessionID>string</SessionID>
</SoapSecurityHeader>
</soap:Header>
<soap:Body>
<PollForMessages xmlns=“http://pia.premiereglobal.com/” />
</soap:Body>
</soap:Envelope>

An exemplary XML response for the PollForMessages( ) all may be configured as follows:

<?xml version=“1.0” encoding=“utf-8”?>
<soap:Envelope xmlns:xsi=“http://www.w3.org/2001/XMLSchema-
instance”
xmlns:xsd=“http://www.w3.org/2001/XMLSchema” xmlns:soap=“http://
schemas.xmlsoap.org/soap/envelope/”>
<soap:Body>
<PollForMessagesResponse xmlns=“http://pia.premiereglobal.com/”>
<PollingRequestResult>
<ResultCode>ResultCode</ResultCode>
</PollingRequestResult>
</PollForMessagesResponse>
</soap:Body>
</soap:Envelope>

The authentication service 608, the conference schedule service 610, and the join conference service 612 may enable the conferencing notification application 118 to interface with a registration system. The authentication service 608 may invoke a SecurityValidateLogOn( ) call to validate a user's logon credentials. The call may return a security token, which may be used to create a login header. The login header may be sent with one or more of the other service calls. An exemplary XML request for the SecurityValidateLogOn( ) call may be configured as follows:

<?xml version=“1.0” encoding=“utf-8”?>
<soap:Envelope xmlns:xsi=“http://www.w3.org/2001/XMLSchema-
instance” xmlns:xsd=“http://www.w3.org/2001/XMLSchema”
xmlns:soap=“http://schemas.xmlsoap.org/soap/envelope/”>

<soap:Body>

<SecurityValidateLogOn xmlns=“Conferencing”>

<request>

<LogOnId>string</LogOnId>
<Password>string</Password>
<WebId>string</WebId>
<WebPassword>string</WebPassword>

</request>

</SecurityValidateLogOn>

</soap:Body>

</soap:Envelope>

An exemplary XML response for the SecurityValidateLogOn( ) call may be configured as follows:

<?xml version=“1.0” encoding=“utf-8”?>
<soap:Envelope xmlns:xsi=“http://www.w3.org/2001/XMLSchema-
instance” xmlns:xsd=“http://www.w3.org/2001/XMLSchema”
xmlns:soap=“http://schemas.xmlsoap.org/soap/envelope/”>

<soap:Body>

<SecurityValidateLogOnResponse xmlns=“Conferencing”>

<SecurityValidateLogOnResult>

<Token>guid</Token>
<TokenExpirationUtc>dateTime</TokenExpirationUtc>
<FirstName>string</FirstName>
<LastName>string</LastName>
<Email>string</Email>
<ClientId>int</ClientId>
<IntlClientId>string</IntlClientId>
<ProviderId>int</ProviderId>
<ProviderName>string</ProviderName>
<CompanyId>int</CompanyId>
<IntlCompanyId>string</IntlCompanyId>
<CompanyName>string</CompanyName>
<CorporateCustomerId>int</CorporateCustomerId>
<CorporateCustomerName>string</CorporateCustomerName>
<HubId>int</HubId>
<HubName>string</HubName>
<HubGroupId>int</HubGroupId>
<HubGroupName>string</HubGroupName>
<HubUrls>

<string>string</string>
<string>string</string>

</HubUrls>
<RedFlagDate>dateTime</RedFlagDate>
<FinanceChangeDate>dateTime</FinanceChangeDate>

</SecurityValidateLogOnResult>

</SecurityValidateLogOnResponse>

</soap:Body>

</soap:Envelope>

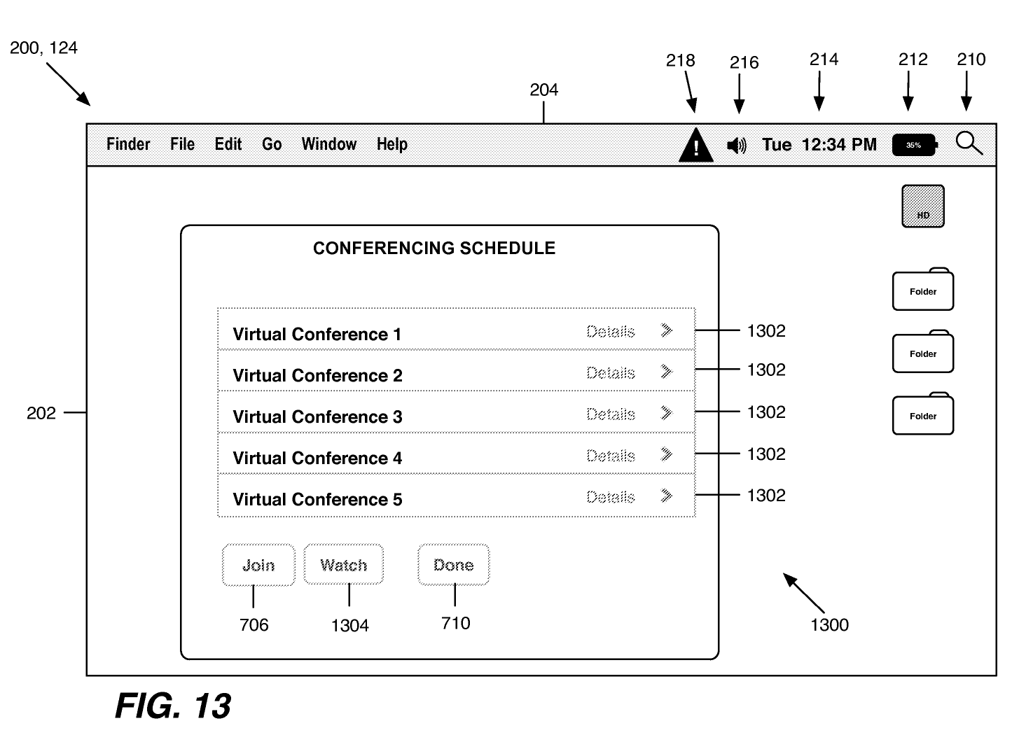

The conference schedule service 610 may invoke a FindReservation( ) call that returns a list of conferences. The FindReservation( ) call may be initiated when a user selects the Conference Scheduler button 516, as illustrated in FIG. 5. The result contains detailed information of all conferences associated with the user. The conferencing notification application 118 may present the results to the user. FIG. 13 illustrates an exemplary display 1300 for presenting the results. The display 1300 comprises a list of conference entries 1302. Additional details (e.g., dial-in numbers, passcodes, date, time, agenda, participants, etc.) about each conference may be accessed by selecting the particular entry 6102. As illustrated in FIG. 13, when a nonparticipant 103 wants to watch a conference to receive alerts about that conference, the nonparticipant 103 may select an entry 1302 and select a watch button 1304.

An exemplary XML request for the FindReservation( ) call may be configured as follows:

<?xml version=“1.0” encoding=“utf-8”?>
<soap:Envelope xmlns:xsi=“http://www.w3.org/2001/XMLSchema-
instance” xmlns:xsd=“http://www.w3.org/2001/XMLSchema”
xmlns:soap=“http://schemas.xmlsoap.org/soap/envelope/”>

<soap:Header>

<HeaderToken xmlns=“Conferencing”>

<Token>string</Token>

</HeaderToken>

</soap:Header>
<soap:Body>

<FindReservation xmlns=“Conferencing”>

<aFindReservationRequest TimeZone=“string”

DisplayLanguage=“string”>

<SearchCriteria CompanyID=“string”

ClientID=“string” ConfID=“string” PPassCode=“string”
ClientPassCode=“string” ConfName=“string”
ModeratorName=“string” StartDate=“string”
EndDate=“string” AddDeleted=“string” MaxRecords=“string”
StartRecord=“string” InterfaceID=“string”
SortByModified=“string”>

<ConfTypes>

<ConfType>string</ConfType>
<ConfType>string</ConfType>

</ConfTypes>

</SearchCriteria>

</aFindReservationRequest>
<aIgnoreUserId>boolean</aIgnoreUserId>

</FindReservation>

</soap:Body>

</soap:Envelope>

An exemplary XML response for the FindReservation( ) call may be configured as follows:

<?xml version=“1.0” encoding=“utf-8”?>
<soap:Envelope xmlns:xsi=“http://www.w3.org/2001/XMLSchema-
instance” xmlns:xsd=“http://www.w3.org/2001/XMLSchema”
xmlns:soap=“http://schemas.xmlsoap.org/soap/envelope/”>

<soap:Body>

<FindReservationResponse xmlns=“Conferencing”>

<FindReservationResult Count=“string”>
<Result ErrorCode=“string” ErrorText=“string” />

<Reservation Deleted=“string” DeleteDate=“string”
Created=“string” Modified=“string” Attended=“string”
Participants=“string”>
<ReservationDetails ConfID=“string” ConfName=“string”
PPassCode=“string” MPassCode=“string”
LPassCode=“string” ClientPassCode=“string”
ClientMPassCode=“string” SecurityCode=“string”
PassCodeType=“string”>
<PhoneNumbers xsi:nil=“true” />

</ReservationDetails>

<Client ClientID=“string” ConfName=“string”
Password=“string” Email=“string” Company=“string”
PONumber=“string” ModeratorName=“string”
InterfaceID=“string” SystemID=“string”
MinutesAvailable=“string” SecurityCode=“string”
RSVPCustom=“string” Language=“string”
DisplayLanguage=“string” ClientNumMinLen=“string”
ClientNumMaxLen=“string” MatterNumMinLen=“string”
MatterNumMaxLen=“string” PONumMinLen=“string”
PONumMaxLen=“string” />
<BridgeOptions>

<BridgeOption>string</BridgeOption>
<BridgeOption>string</BridgeOption>
<Option xsi:nil=“true” />
<Option xsi:nil=“true” />

</BridgeOptions>

<Options>

<Option xsi:nil=“true” />
<Option xsi:nil=“true” />

</Options>

<Schedule TimeZone=“string” TimeZoneName=“string”>

<AdHoc xsi:nil=“true” />
<AdHoc xsi:nil=“true” />
<Daily xsi:nil=“true” />
<Daily xsi:nil=“true” />
<Weekly xsi:nil=“true” />
<Weekly xsi:nil=“true” />
<WeekDays xsi:nil=“true” />
<WeekDays xsi:nil=“true” />
<MonthlyDesc xsi:nil=“true” />
<MonthlyDesc xsi:nil=“true” />
<MonthlyDate xsi:nil=“true” />
<MonthlyDate xsi:nil=“true” />
<Skip xsi:nil=“true” />
<Skip xsi:nil=“true” />
<NextConference xsi:nil=“true” />
<NextConference xsi:nil=“true” />
<ConferenceTime xsi:nil=“true” />
<ConferenceTime xsi:nil=“true” />

</Schedule>

<PhoneURL Value=“string” />

<VisionCast ParticipantURL=“string”

ModeratorURL=“string” ReplayURL=“string” />

</Reservation>

<Reservation Deleted=“string” DeleteDate=“string”

Created=“string” Modified=“string”
Attended=“string” Participants=“string”>

```
  <ReservationDetails ConfID=“string” ConfName=“string”
  PPassCode=“string” MPassCode=“string”
  LPassCode=“string” ClientPassCode=“string”
  ClientMPassCode=“string” SecurityCode=“string”
  PassCodeType=“string”>
```

<PhoneNumbers xsi:nil=“true” />
</ReservationDetails>

<Client ClientID=“string” ConfName=“string”
Password=“string” Email=“string” Company=“string”
PONumber=“string” ModeratorName=“string”
InterfaceID=“string” SystemID=“string”
MinutesAvailable=“string” SecurityCode=“string”
RSVPCustom=“string” Language=“string”
DisplayLanguage=“string” ClientNumMinLen=“string”
ClientNumMaxLen=“string” MatterNumMinLen=“string”
MatterNumMaxLen=“string” PONumMinLen=“string”
PONumMaxLen=“string” />

<BridgeOptions>

<BridgeOption>string</BridgeOption>
<BridgeOption>string</BridgeOption>
<Option xsi:nil=“true” />
<Option xsi:nil=“true” />

</BridgeOptions>

<Options>

<Option xsi:nil=“true” />
<Option xsi:nil=“true” />

</Options>

<Schedule TimeZone=“string” TimeZoneName=“string”>

<AdHoc xsi:nil=“true” />
<AdHoc xsi:nil=“true” />
<Daily xsi:nil=“true” />
<Daily xsi:nil=“true” />
<Weekly xsi:nil=“true” />
<Weekly xsi:nil=“true” />
<WeekDays xsi:nil=“true” />
<WeekDays xsi:nil=“true” />
<MonthlyDesc xsi:nil=“true” />
<MonthlyDesc xsi:nil=“true” />
<MonthlyDate xsi:nil=“true” />
<MonthlyDate xsi:nil=“true” />
<Skip xsi:nil=“true” />
<Skip xsi:nil=“true” />
<NextConference xsi:nil=“true” />
<NextConference xsi:nil=“true” />
<ConferenceTime xsi:nil=“true” />
<ConferenceTime xsi:nil=“true” />

</Schedule>
<PhoneURL Value=“string” />
<VisionCast ParticipantURL=“string”

ModeratorURL=“string” ReplayURL=“string” />

</Reservation>

</FindReservationResult>

</FindReservationResponse>

</soap:Body>

</soap:Envelope>

The join conference service 612 may be invoked when, for example, the nonparticipant 103 selects the join button 706 or selects a conference from the conferencing schedule. A WebHostLogin( ) call may return a location for the virtual conference location. In an embodiment, the call may return a redirectUrl of a given client and host, which logs the client into a host. The conferencing notification application 118 may send the WebHostLogin( ) request, which contains the user's credentials, and then opens a web browser placing the user directly into the conference without the need to login again.

An exemplary XML response for the WebHostLogin( ) call may be configured as follows:

<?xml version=“1.0” encoding=“utf-8”?>
<soap:Envelope xmlns:xsi=“http://www.w3.org/2001/XMLSchema-
instance” xmlns:xsd=“http://www.w3.org/2001/XMLSchema”
xmlns:soap=“http://schemas.xmlsoap.org/soap/envelope/”>

<soap:Header>

<HeaderToken xmlns=“Conferencing”>

<Token>string</Token>

</HeaderToken>

</soap:Header>
<soap:Body>

<WebHostLogin xmlns=“Conferencing”>

<request>

<ClientId>string</ClientId>
<WebHost>None or VisionCast or VisionCastDemo or

ReadyCast or ReadyCastDemo or ReadyCastProtect or
AcrobatConnectPro or PgiAdobeConnect or ReadyCastMeeting
or ReadyCastEvent or ConferencingHub</WebHost>

<ConfId>int</ConfId>
<DialInNumbers>

<PhoneNumber>

<Location>string</Location>
<Number>string</Number>

</PhoneNumber>
<PhoneNumber>

<Location>string</Location>
<Number>string</Number>

</PhoneNumber>

</DialInNumbers>
<Target>string</Target>

</request>

</WebHostLogin>

</soap:Body>

</soap:Envelope>

An exemplary XML response for the WebHostLogin( ) call may be configured as follows:

<?xml version=“1.0” encoding=“utf-8”?>
<soap:Envelope xmlns:xsi=“http://www.w3.org/2001/XMLSchema-
instance” xmlns:xsd=“http://www.w3.org/2001/XMLSchema”
xmlns:soap=“http://schemas.xmlsoap.org/soap/envelope/”>

<soap:Body>

<WebHostLoginResponse xmlns=“Conferencing”>

<WebHostLoginResult>

<RedirectUrl>string</RedirectUrl>

</WebHostLoginResult>

</WebHostLoginResponse>

</soap:Body>

</soap:Envelope>

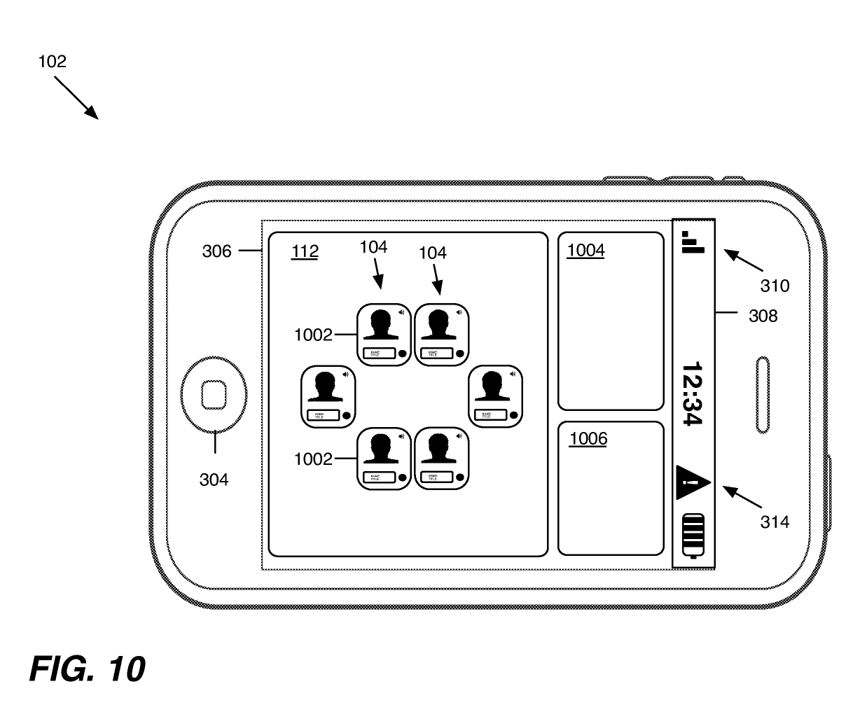

After selecting the join conference button 706 (FIG. 9), the nonparticipant 103 may be added as a participant 104 to the conference. FIG. 10 illustrates a user interface screen shot illustrating an embodiment of the conference interface 112 presented to a mobile computing device 102. As described in more detail in the parent patent application, U.S. patent application Ser. No. 12/771,979, the conference user interface 112 may display a plurality of participant objects 1002 associated with each of the participants 104. It should be appreciated that additional content and/or functionality may be presented in one or more additional screen portions 1004 and 1006.

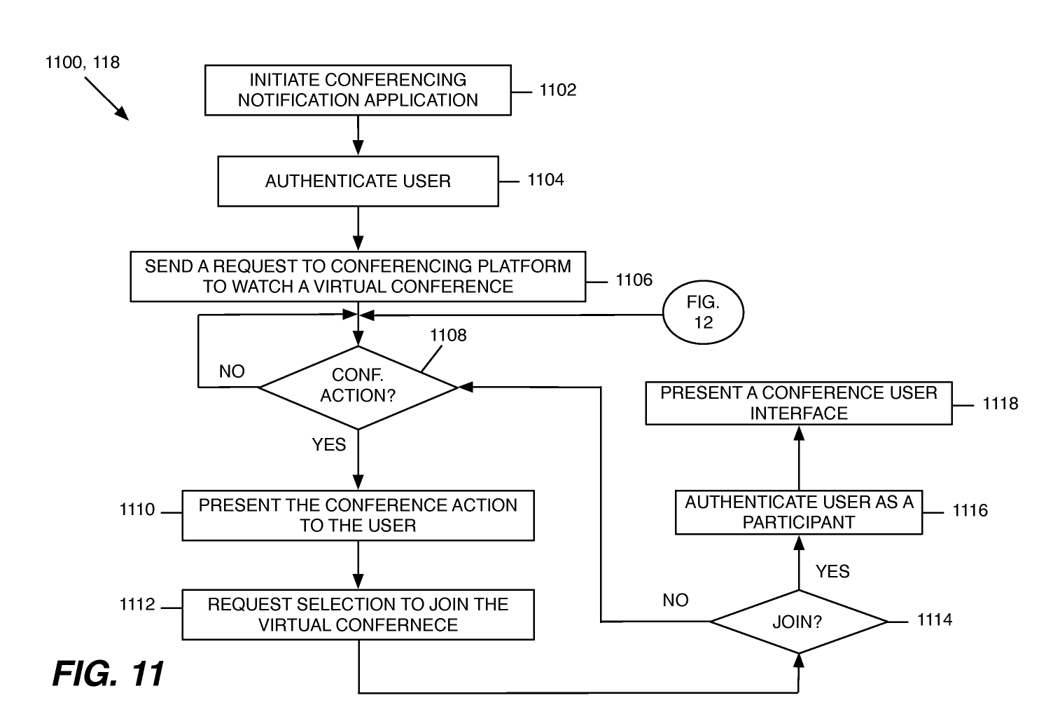

FIG. 11 illustrates an embodiment of a method 1100 for enabling a nonparticipant 103 to watch a conference via the conferencing notification application 118 without having to join the audio conference 114 or access the conference interface 112. At block 1102, the conferencing notification application 118 is initiated. A nonparticipant 103 may manually launch the conferencing notification application 118 or the operating system 122 may be configured to automatically launch the application at startup or upon a predetermined event. At block 1104, the conferencing notification application 118 may authenticate the user with the conferencing system 106. At block 1106, the conferencing notification application 118 sends a request to the conferencing system 106 to watch a virtual conference. The request may comprise information identifying the conference. At decision block 1108, the conference and/or the audio conference 114 are monitored for specific actions or events. As events occur during the audio conference 114, the conferencing notification application 118 may receive and present related messages or alerts to the nonparticipant 103 (block 1110). At block 1112, the conferencing notification application 118 may prompt the nonparticipant 103 for a selection to join the conference via the conference interface. In an embodiment, the request to join may be presented in association with the message or alert. If the user makes a selection to join the virtual conference (decision block 1114), the conferencing notification application 118 may further authenticate the user 103 as a participant in the conference, at block 1116. This authentication may substitute for the authentication at block 1104 or provide further or separate authentication. At block 1118, the conferencing notification application 118 enables the user to access the conference via, for example, the conference user interface 112.

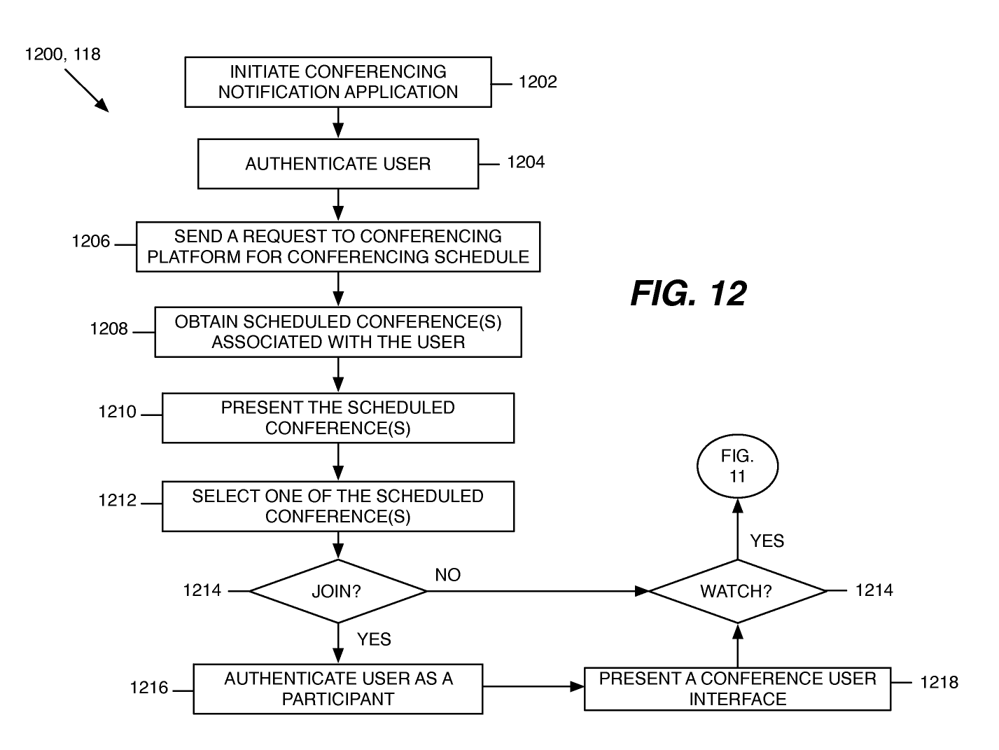

FIG. 12 illustrates another embodiment of a method 1200 for implementing certain aspects of the conferencing notification application 118. The conferencing notification application 118 is initiated, at block 1202. At block 1204, the conferencing notification application 118 may authenticate the user with the conferencing system 106. At block 1206, the conferencing notification application 118 sends a request to the conferencing system 106 for available conferences associated with the user. At decision block 1208, the conferencing notification application 118 may receive a schedule of conferences associated with the user, which may be presented to the nonparticipant 103 (block 1210). At block 1212, the conferencing notification application 118 may prompt the nonparticipant 103 for a selection of one of the conferences (block 1212). If the user requests to join the selected conference (decision block 1214), the user may be authenticated (block 1216) and then permitted to join the audio conference 114 and/or the virtual conference. As illustrated at decision block 1214, the user may also request to watch the conference without necessarily joining the conference.

FIG. 14 illustrates an embodiment of a method 400 for implementing the out-of-conference messaging feature. As mentioned above, this service enables the nonparticipant 103 to exchange messages with the participants 104 without necessarily joining the conference. At block 1402, the conferencing notification application 118 is launched. At block 1404, the nonparticipant 103 may be authenticated as described above. The conferencing system 106 may determine the occurrence of a predetermined conference event (decision block 1406). When a conference event is determined, an alert or notification may be presented to the computing device 102, as indicated in block 1408. The nonparticipant 103 may be prompted to join the conference or the conferencing notification application 118 may automatically add the nonparticipant 103 in response to a predetermined event (decision block 1410). In an embodiment, the nonparticipant 103 may configure the conferencing notification application 118 such that the conferencing system 106 automatically initiates a dial-out to a predetermined number (or sends a text message or email message) if the conferencing notification application 118 is not currently active on a computing device 102 associated with the nonparticipant 103. At blocks 1414 and 1416, the conferencing notification application 118 enables the nonparticipant 103 to exchange out-of-conference messages with one or more participants 104 without being added to the conference as a participant. The out-of-conference messages may be transmitted via the conferencing system 106 and presented to the particular participant 104 via the conference user interface 112.

In alternative embodiments, the out-of-conference messages may be delivered via an external delivery mechanism (e.g., a social network system, email system, etc.) by enabling the conferencing notification application 118 to access a local or remote directory or web service of the nonparticipant's contacts or social networking connections. For example, the conferencing system 106 may pass the identity of a particular participant 104 to the conferencing notification application 118. The conferencing notification application 118 may then cross-reference a local or remote contacts database or the nonparticipant's social networking profile to determine appropriate delivery parameters.

It should be appreciated that one or more of the process or method descriptions associated with the flow charts or block diagrams above may represent modules, segments, logic or portions of code that include one or more executable instructions for implementing logical functions or steps in the process. It should be further appreciated that the logical functions may be implemented in software, hardware, firmware, or any combination thereof. In certain embodiments, the logical functions may be implemented in software or firmware that is stored in memory or non-volatile memory and that is executed by hardware (e.g., microcontroller) or any other processor(s) or suitable instruction execution system associated with the multi-platform virtual conference location system. Furthermore, the logical functions may be embodied in any computer readable medium for use by or in connection with an instruction execution system, apparatus, or device, such as a computer-based system, processor-containing system, or other system associated with the multi-platform virtual conference location system that can fetch the instructions from the instruction execution system, apparatus, or device and execute the instructions.

It should be noted that this disclosure has been presented with reference to one or more exemplary or described embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

1. A method for monitoring an audio conference without joining as a participant, the method comprising:
a client device, which is associated with an individual who has not joined an audio conference, sending a request via a communication network to a conferencing system to be notified of a predetermined event associated with the audio conference;
the conferencing system determining the occurrence of the predetermined event;
the conferencing system sending a notification to the client device indicating the occurrence of the predetermined event;
the client device presenting the notification to the individual;
without joining the audio conference, the client device sending an out-of-conference message from the individual to the conferencing system; and
the conferencing system presenting the out-of-conference message to one or more participants in the audio conference.

2. The method of claim 1, wherein the predetermined event comprises one or more of the participants joining the audio conference.

3. The method of claim 1, wherein the conferencing system determining the occurrence of the predetermined event occurs comprises: the conferencing system determining a current number of participants in the audio conference.

4. The method of claim 1, wherein the client device sending the request to the conferencing system comprises: the client device polling the conferencing system.

5. The method of claim 1, wherein the client device presenting the notification comprises: the client device prompting a host to join the audio conference.

6. The method of claim 1, wherein the individual comprises a host associated with the audio conference.

7. The method of claim 1, wherein the notification is presented with a prompt for one or more of the following actions: join the audio conference; and compose the out-of-conference message.

8. The method of claim 1, further comprising:
the conferencing system receiving a reply to the out-of-conference message from one or more of the participants; and
the conferencing system sending the reply to the individual without joining the audio conference.

9. The method of claim 1, wherein the client device sending the request to the conferencing system comprises:
initiating a conference notification application on the client device; and
accessing an application program interface associated with the conferencing system.

10. The method of claim 9, wherein the conference notification application comprises a desktop notification application associated with an operating system.

11. A computer system for monitoring an online conference without joining as a participant, the computer system comprising:
a conference platform for providing an online conference to a plurality of participants via a communication network; and
a client device operated by a nonparticipant of the online conference, the client device comprising:
a processor and a memory; and
a conferencing notification application embodied in the memory and executed by the processor, the conferencing notification application comprising:
logic configured to send a request to the conference platform to be notified of a predetermined event associated with the online conference without joining the online conference;
logic configured to receive a notification from the conference platform when the predetermined event occurs; and
logic configured to enable the nonparticipant to send a message to one or more of the participants without joining the online conference.

12. The computer system of claim 11, wherein the predetermined event comprises one or more of the following: one or more of the participants joining an audio conference; a predetermined participant joining the audio conference; a predetermined number of participants joining the audio conference; and an incoming out-of-conference message from one of the participants.

13. The computer system of claim 11, wherein the logic configured to send the request to the conference platform comprises: logic configured to poll the conference platform.

14. The computer system of claim 11, wherein the conference notification application further comprises: logic configured to display the notification to the nonparticipant and prompt the nonparticipant to join an audio conference.

15. The computer system of claim 11, wherein the conference notification application comprises a desktop notification application.

16. The computer system of claim 11, wherein the conference notification application further comprises: logic configured to receive a reply to the message from the conference platform without joining the online conference.

17. The computer system of claim 11, wherein the conference notification application communicates with the conference platform via an application program interface.

18. A desktop notification computer program embodied in a computer readable medium and executed by a processor for monitoring a conference and providing notifications to a graphical user interface associated with a desktop, the desktop notification computer program comprising:
logic configured to send a request to a conference platform to be notified of an occurrence of an event associated with a conference without a user joining as a participant;
logic configured to receive a notification from the conference platform when the predetermined event occurs; and
logic configured to send an out-of-conference message to one or more participants in the audio conference without joining the conference.

19. The desktop notification computer program of claim 18, wherein the logic configured to send the out-of-conference message comprises:
logic configured to receive an identity of at least one of the participants from the conferencing system; and
logic configured to send the out-of-conference message to the at least one of the participants via one of a social networking channel, an instant message, and an email message.

20. The desktop notification computer program of claim 19, wherein the out-of-conference message is delivered via the conferencing system and presented via a conference user interface to the participants.

21. The computer system of claim 11, wherein the conference platform is configured to send the notification to the nonparticipant via one of a text message or an email message when the conferencing notification application is not active on the client device.

22. The method of claim 1, wherein the conferencing system sending the notification to the client device comprises sending one of a text message or an email message.

23. A method for monitoring an audio conference without joining as a participant, the method comprising:
a conferencing system establishing an audio conference between a plurality of participants accessing the conferencing system via a computing device;
the conferencing system determining that a conference notification application associated with an individual who has not joined the audio conference is not currently active on a computing device;
the conferencing system determining an occurrence of a predetermined event associated with the audio conference; and
if the conference notification application is not currently active and the individual has not joined the audio conference, the conferencing system sending one of a text message or an email message to the individual indicating the occurrence of the predetermined event.

24. The method of claim 23, wherein the predetermined event comprises one or more of the following: one or more of the participants joining the audio conference; a predetermined participant joining the audio conference; a predetermined number of participants joining the audio conference; and an incoming out-of-conference message from one of the participants.
